(19) United States
(12) Patent Application Publication
(10) Pub. No.: US 2022/0307861 A1
(43) Pub. Date: Sep. 29, 2022

(54) MAP GENERATION APPARATUS

(71) Applicant: Honda Motor Co., Ltd., Tokyo (JP)

(72) Inventor: Yuichi Konishi, Wako-shi (JP)

(21) Appl. No.: 17/676,756

(22) Filed: Feb. 21, 2022

(30) Foreign Application Priority Data
Mar. 26, 2021 (JP) 2021-053872

(51) Int. Cl. G01C 21/00; G06V 20/58

(52) U.S. Cl. CPC G01C 21/3867; G01C 21/387; G01C 21/3889; G01C 21/3822; G06V 20/58

(57) ABSTRACT

A map generation apparatus includes: an external situation detector configured to detect an external situation around a subject vehicle; and a microprocessor and a memory connected to the microprocessor. The microprocessor is configured to perform: extracting one or more feature points from an image indicated by a detection data acquired by the external situation detector; estimating a moving amount of the external situation detector accompanying the movement of the subject vehicle based on the image indicated by the detection data; specifying a region in the image used for estimation of the moving amount in the estimating; and generating a map information using one or more feature points corresponding to the region specified in the specifying among the feature points extracted in the extracting.

### CROSS-REFERENCE TO RELATED APPLICATION

This application is based upon and claims the benefit of priority from Japanese Patent Application No. 2021-053872 filed on Mar. 26, 2021, the content of which are incorporated herein by reference.

### BACKGROUND OF THE INVENTION

### Field of the Invention

This invention relates to a map generation apparatus configured to generate a map of an area around a vehicle.

### Description of the Related Art

As this type of device, conventionally, for the purpose of generating a highly accurate map, there is known a device that generates a feature-point map based on captured images acquired by in-vehicle cameras of a plurality of vehicles, and superimposes the generated feature-point maps to generate a wide area map (for example, see JP 2020-518917 A).

However, when an attempt is made to generate a highly accurate map as in the device described in JP 2020-518917 A, there is a possibility that an amount of data of the map increases accordingly and a capacity of a storage device that stores the map is largely taken up.

### SUMMARY OF THE INVENTION

An aspect of the present invention is a map generation apparatus including: an external situation detector configured to detect an external situation around a subject vehicle; and a microprocessor and a memory connected to the microprocessor. The microprocessor is configured to perform: extracting one or more feature points from an image indicated by a detection data acquired by the external situation detector; estimating a moving amount of the external situation detector accompanying the movement of the subject vehicle based on the image indicated by the detection data; specifying a region in the image used for estimation of the moving amount in the estimating; and generating a map information using one or more feature points corresponding to the region specified in the specifying among the feature points extracted in the extracting.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system according to an embodiment of the present invention;

FIG. 2 is a block diagram illustrating a main part configuration of the map generation apparatus according to an embodiment of the present invention;

FIG. 3 is a flowchart illustrating one example of processing executed by the controller in FIG. 2;

FIG. 4A is a diagram illustrating an example of a captured image of a camera;

FIG. 4B is a diagram schematically illustrating an attention map;

FIG. 4C is a diagram schematically illustrating feature points extracted from the captured image of FIG. 4A; and

FIG. 4D is a diagram schematically illustrating feature points corresponding to an attention region.

### DETAILED DESCRIPTION OF THE INVENTION

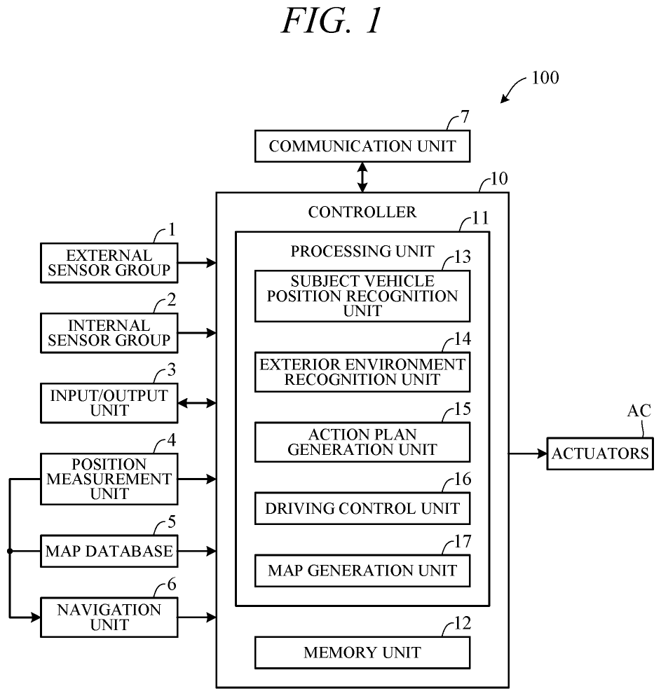

An embodiment of the present invention will be described below with reference to FIGS. 1 to 4D. A map generation apparatus according to the embodiment of the present invention can be applied to a vehicle including a self-driving capability, that is, a self-driving vehicle. It is to be noted that a vehicle to which the map generation apparatus according to the present embodiment is applied may be referred to as a subject vehicle as distinguished from other vehicles. The subject vehicle may be any of an engine vehicle including an internal combustion (engine) as a traveling drive source, an electric vehicle including a traveling motor as a traveling drive source, and a hybrid vehicle including an engine and a traveling motor as a traveling drive source. The subject vehicle can travel not only in a self-drive mode in which a driving operation by a driver is unnecessary, but also in a manual drive mode by the driving operation by the driver.

First, a schematic configuration related to self-driving will be described. FIG. 1 is a block diagram schematically illustrating an overall configuration of a vehicle control system 100 including a map generation apparatus according to the present embodiment of the present invention. As illustrated in FIG. 1, the vehicle control system 100 mainly includes a controller 10, an external sensor group 1, an internal sensor group 2, an input/output device 3, a position measurement unit 4, a map database 5, a navigation unit 6, a communication unit 7, and a traveling actuator AC each communicably connected to the controller 10.

The external sensor group 1 is a generic term for a plurality of sensors (external sensors) that detect an external situation which is peripheral information of a subject vehicle. For example, the external sensor group 1 includes a LiDAR that measures scattered light with respect to irradiation light in all directions of the subject vehicle and measures a distance from the subject vehicle to a surrounding obstacle, a radar that detects other vehicles, obstacles, or the like around the subject vehicle by irradiating electromagnetic waves and detecting a reflected wave, and a camera that is mounted on the subject vehicle and has an imaging element such as a CCD or a CMOS to image the periphery of the subject vehicle (forward, rearward and lateral).

The internal sensor group 2 is a generic term for a plurality of sensors (internal sensors) that detect a traveling state of the subject vehicle. For example, the internal sensor group 2 includes a vehicle speed sensor that detects a vehicle speed of the subject vehicle, an acceleration sensor that detects an acceleration in a front-rear direction of the subject vehicle and an acceleration in a left-right direction (lateral acceleration) of the subject vehicle, a revolution sensor that detects the number of revolution of the traveling drive source, a yaw rate sensor that detects a rotation angular speed around a vertical axis of the center of gravity of the subject vehicle, and the like. The internal sensor group 2 further includes a sensor that detects driver's driving operation in a manual drive mode, for example, operation of an accelerator pedal, operation of a brake pedal, operation of a steering wheel, and the like.

The input/output device 3 is a generic term for devices in which a command is input from a driver or information is output to the driver. For example, the input/output device 3 includes various switches to which the driver inputs various commands by operating an operation member, a microphone to which the driver inputs a command by voice, a display that provides information to the driver with a display image, a speaker that provides information to the driver by voice, and the like.

The position measurement unit (GNSS unit) 4 has a positioning sensor that receives a positioning signal transmitted from a positioning satellite. The positioning satellite is an artificial satellite such as a global positioning system (GPS) satellite or a quasi-zenith satellite. The position measurement unit 4 measures a current position (latitude, longitude, altitude) of the subject vehicle by using the positioning information received by the positioning sensor.

The map database 5 is a device that stores general map information used in the navigation unit 6, and is constituted of, for example, a hard disk or a semiconductor element. The map information includes road position information, information on a road shape (curvature or the like), position information on intersections and branch points, and information on a speed limit set for the road. The map information stored in the map database 5 is different from highly accurate map information stored in a memory unit 12 of the controller 10.

The navigation unit 6 is a device that searches for a target route on a road to a destination input by a driver and provides guidance along the target route. The input of the destination and the guidance along the target route are performed via the input/output device 3. The target route is calculated based on a current position of the subject vehicle measured by the position measurement unit 4 and the map information stored in the map database 5. The current position of the subject vehicle can be measured using the detection values of the external sensor group 1, and the target route may be calculated on the basis of the current position and the highly accurate map information stored in the memory unit 12.

The communication unit 7 communicates with various servers (not illustrated) via a network including a wireless communication network represented by the Internet network, a mobile phone network, or the like, and acquires map information, travel history information, traffic information, and the like from the servers periodically or at an arbitrary timing. The network includes not only a public wireless communication network but also a closed communication network provided for each predetermined management region, for example, a wireless LAN, Wi-Fi (registered trademark), Bluetooth (registered trademark), and the like. The acquired map information is output to the map database 5 and the memory unit 12, and the map information is updated.

The actuator AC is a traveling actuator for controlling traveling of the subject vehicle. In a case where the traveling drive source is an engine, the actuator AC includes a throttle actuator that adjusts an opening (throttle opening) of a throttle valve of the engine. In the case where the traveling drive source is a traveling motor, the actuator AC includes therein the traveling motor. The actuator AC also includes a brake actuator that operates a braking device of the subject vehicle and a steering actuator that drives a steering device.

The controller 10 includes an electronic control unit (ECU). More specifically, the controller 10 includes a computer that has a processing unit 11 such as a central processing unit (CPU) (microprocessor), a memory unit 12 such as a read only memory (ROM) and a random access memory (RAM), and other peripheral circuits (not illustrated) such as an input/output (I/O) interface. Although a plurality of ECUs having different functions such as an engine control ECU, a traveling motor control ECU, and a braking device ECU can be separately provided, in FIG. 1, the controller 10 is illustrated as a set of these ECUs for convenience.

The memory unit 12 stores highly accurate detailed map information (referred to as highly accurate map information). The highly accurate map information includes road position information, information on a road shape (curvature or the like), information on a road gradient, position information on an intersection or a branch point, information on the number of lanes, width of a lane and position information for each lane (information of a center position of a lane or a boundary line of a lane position), position information on a landmark (traffic lights, signs, buildings, etc.) as a mark on a map, and information on a road surface profile such as unevenness of a road surface. The highly accurate map information stored in the memory unit 12 includes map information acquired from the outside of the subject vehicle via the communication unit 7, for example, information of a map (referred to as a cloud map) acquired via a cloud server, and information of a map created by the subject vehicle itself using detection values by the external sensor group 1, for example, information of a map (referred to as an environmental map) including point cloud data generated by mapping using a technology such as simultaneous localization and mapping (SLAM). The memory unit 12 also stores information on various control programs and thresholds used in the programs.

The processing unit 11 includes a subject vehicle position recognition unit 13, an exterior environment recognition unit 14, an action plan generation unit 15, a driving control unit 16, and a map generation unit 17 as functional configurations.

The subject vehicle position recognition unit 13 recognizes the position (subject vehicle position) of the subject vehicle on a map, based on the position information of the subject vehicle, obtained by the position measurement unit 4, and the map information of the map database 5. The subject vehicle position may be recognized using the map information stored in the memory unit 12 and the peripheral information of the subject vehicle detected by the external sensor group 1, whereby the subject vehicle position can be recognized with high accuracy. When the subject vehicle position can be measured by a sensor installed on the road or outside a road side, the subject vehicle position can be recognized by communicating with the sensor via the communication unit 7.

The exterior environment recognition unit 14 recognizes an external situation around the subject vehicle, based on the signal from the external sensor group 1 such as a LiDAR, a radar, and a camera. For example, the position, traveling speed, and acceleration of a surrounding vehicle (a forward vehicle or a rearward vehicle) traveling around the subject vehicle, the position of a surrounding vehicle stopped or parked around the subject vehicle, the positions and states of other objects and the like are recognized. Other objects include signs, traffic lights, markings (road markings) such as division lines and stop lines of roads, buildings, guardrails, utility poles, signboards, pedestrians, bicycles, and the like. The states of other objects include a color of a traffic light (red, green, yellow), the moving speed and direction of a pedestrian or a bicycle, and the like. A part of the stationary object among the other objects constitutes a landmark serving as an index of the position on the map, and the exterior environment recognition unit 14 also recognizes the position and type of the landmark.

The action plan generation unit 15 generates a driving path (target path) of the subject vehicle from a current point of time to a predetermined time T ahead based on, for example, the target route calculated by the navigation unit 6, the subject vehicle position recognized by the subject vehicle position recognition unit 13, and the external situation recognized by the exterior environment recognition unit 14. When there are a plurality of paths that are candidates for the target path on the target route, the action plan generation unit 15 selects, from among the plurality of paths, an optimal path that satisfies criteria such as compliance with laws and regulations and efficient and safe traveling, and sets the selected path as the target path. Then, the action plan generation unit 15 generates an action plan corresponding to the generated target path. The action plan generation unit 15 generates various action plans corresponding to traveling modes, such as overtaking traveling for overtaking a preceding vehicle, lane change traveling for changing a travel lane, following traveling for following a preceding vehicle, lane keeping traveling for keeping the lane so as not to deviate from the travel lane, deceleration traveling, or acceleration traveling. When the action plan generation unit 15 generates the target path, the action plan generation unit 15 first determines a travel mode, and generates the target path based on the travel mode.

In the self-drive mode, the driving control unit 16 controls each of the actuators AC such that the subject vehicle travels along the target path generated by the action plan generation unit 15. More specifically, the driving control unit 16 calculates a requested driving force for obtaining the target acceleration for each unit time calculated by the action plan generation unit 15 in consideration of travel resistance determined by a road gradient or the like in the self-drive mode. Then, for example, the actuator AC is feedback controlled so that an actual acceleration detected by the internal sensor group 2 becomes the target acceleration. More specifically, the actuator AC is controlled so that the subject vehicle travels at the target vehicle speed and the target acceleration. In the manual drive mode, the driving control unit 16 controls each actuator AC in accordance with a travel command (steering operation or the like) from the driver acquired by the internal sensor group 2.

The map generation unit 17 generates the environmental map constituted by three-dimensional point cloud data using detection values detected by the external sensor group 1 during traveling in the manual drive mode. Specifically, an edge indicating an outline of an object is extracted from a captured image data (hereinafter may be simply referred to as a captured image) acquired by a camera 1a based on luminance and color information for each pixel, and a feature point is extracted using the edge information. The feature point is, for example, an intersection of the edges, and corresponds to a corner of a building, a corner of a road sign, or the like. The map generation unit 17 sequentially plots the extracted feature points on the environmental map, thereby generating the environmental map around the road on which the subject vehicle has traveled. The environmental map may be generated by extracting the feature point of an object around the subject vehicle using data acquired by radar or LiDAR instead of the camera. When generating the environmental map, the map generation unit 17 determines whether or not a landmark such as a traffic light, a sign, or a building as a mark on the map is included in the captured image acquired by the camera by, for example, pattern matching processing. When it is determined that the landmark is included, the position and the type of the landmark on the environmental map are recognized based on the captured image. The environmental map includes the landmark information, and the memory unit 12 stores the landmark information.

The subject vehicle position recognition unit 13 performs subject vehicle position estimation processing in parallel with map creation processing by the map generation unit 17. That is, the position of the subject vehicle is estimated and acquired based on a change in the position of the feature point over time. The subject vehicle position recognition unit 13 estimates and acquires the subject vehicle position on the environmental map based on a relative positional relationship with the landmark around the subject vehicle. The map creation processing and the position estimation processing are simultaneously performed, for example, according to an algorithm of SLAM. The map generation unit 17 can generate the environmental map not only when the vehicle travels in the manual drive mode but also when the vehicle travels in the self-drive mode. If the environmental map has already been generated and stored in the memory unit 12, the map generation unit 17 may update the environmental map with a newly obtained feature point.

In the subject vehicle position estimation processing, the feature point extracted from the captured image of the camera 1a is collated (matched) with the environmental map stored in the memory unit 12, and the position of the subject vehicle on the environmental map is estimated. At that time, the position of the subject vehicle is estimated based on the feature point corresponding to the landmark as the mark on the map such as a traffic light, a division line on the road, and a boundary line of the road, among the feature points constituting the environmental map. Therefore, the feature points other than these feature points become unnecessary data in the subject vehicle position estimation processing, and an amount of data of the environmental map is increased more than necessary. On the other hand, when the number of feature points is reduced in order to reduce the data amount of the environmental map, matching accuracy of the feature points may decrease, and accordingly, estimation accuracy of the position of the subject vehicle may decrease. Thus, in consideration of the possibility, a map generation apparatus 50 is configured as follows in the present embodiment:

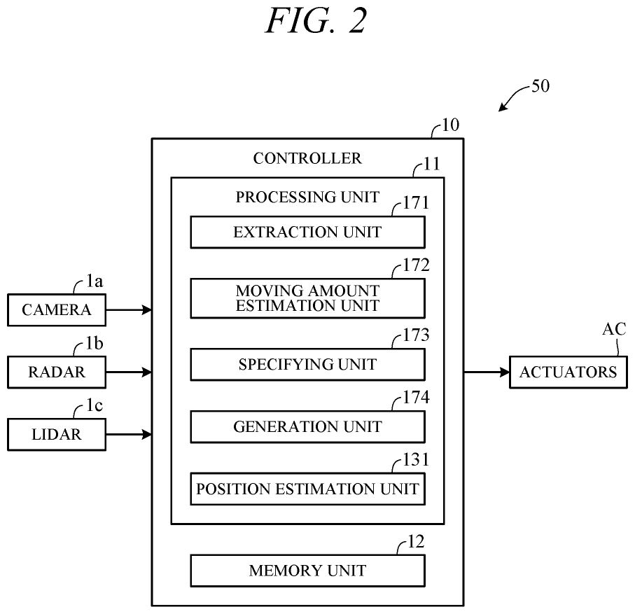

FIG. 2 is a block diagram illustrating a main part configuration of the map generation apparatus 50 according to the embodiment of the present invention. The map generation apparatus 50 constitutes a part of the vehicle control system 100 in FIG. 1. As illustrated in FIG. 2, the map generation apparatus 50 includes the controller 10, a camera 1a, a radar 1b, a LiDAR 1c, and the actuator AC.

The camera 1a is a monocular camera having an imaging element (image sensor) such as a CCD or a CMOS, and constitutes a part of the external sensor group 1 in FIG. 1. The camera 1a may be a stereo camera. The camera 1a images the surroundings of the subject vehicle. The camera 1a is mounted at a predetermined position, for example, in front of the subject vehicle, and continuously captures an image of a space in front of the subject vehicle to acquire image data (hereinafter referred to as captured image data or simply referred to as a captured image) of the object. The camera 1a outputs the captured image to the controller 10. The radar 1b is mounted on the subject vehicle and detects other vehicles, obstacles, and the like around the subject vehicle by irradiating with electromagnetic waves and detecting reflected waves. The radar 1b outputs a detection value (detection data) to the controller 10. The LiDAR 1c is mounted on the subject vehicle, and measures scattered light with respect to irradiation light in all directions of the subject vehicle and detects a distance from the subject vehicle to surrounding obstacles. The LiDAR 1c outputs a detection value (detection data) to the controller 10.

The controller 10 includes a position estimation unit 131, an extraction unit 171, a moving amount estimation unit 172, a specifying unit 173, and a generation unit 174 as a functional configuration that the processing unit 11 (FIG. 1) is responsible for. For example, the position estimation unit 131 is constituted of the subject vehicle position recognition unit 13 in FIG. 1. The extraction unit 171, the moving amount estimation unit 172, the specifying unit 173, and the generation unit 174 are configured by, for example, the map generation unit 17 in FIG. 1.

The extraction unit 171 extracts the feature point from the captured image acquired by the camera 1a. The moving amount estimation unit 172 estimates a moving amount of the camera 1a accompanying a movement of the subject vehicle based on the captured image acquired by the camera 1a. The moving amount estimation unit 172 estimates the moving amount using a poseCNN (pose convolutional neural network). More precisely, the moving amount estimation unit 172 inputs a plurality of captured images, acquired by the camera 1a and having different image capturing time points, to the poseCNN, and acquires an amount of movement (translation and rotation) of the camera 1a estimated by the poseCNN based on the captured images. The poseCNN is a convolutional neural network that estimates the moving amount of a camera that has captured a plurality of input images based on the plurality of input images.

The specifying unit 173 specifies a region in the captured image used for the estimation of the moving amount by the moving amount estimation unit 172. Specifically, the specifying unit 173 specifies an attention region gazed when the poseCNN estimates the moving amount among the regions of the captured image acquired by the camera 1a. The specifying unit 173 specifies the attention region by applying ABN (Attention Branch Network) to the poseCNN The ABN is a method of generating and outputting an attention map indicating the attention region based on an image feature amount obtained from a convolutional layer of the poseCNN. When estimation of the moving amount by the poseCNN is performed in the moving amount estimation unit 172, the specifying unit 173 acquires the image feature amount output from the convolutional layer of the poseCNN, inputs the image feature amount to the ABN, and acquires the attention map output by the ABN. Then, the specifying unit 173 specifies the attention region based on the attention map.

The generation unit 174 plots the feature points, corresponding to the attention region specified by the specifying unit 173 among the feature points extracted by the extraction unit 171, on the environmental map stored in the memory unit 12. As a result, the environmental map around the road on which the subject vehicle has traveled is sequentially generated.

The position estimation unit 131 estimates the position of the subject vehicle by integrating the moving amount estimated by the moving amount estimation unit 172 from a predetermined position. Furthermore, the position estimation unit 131 estimates the position of the subject vehicle based on the feature point extracted by the extraction unit 171 and the environmental map stored in the memory unit 12. The generation processing of the map information by the generation unit 174 and the subject vehicle position estimation processing by the position estimation unit 131 are performed in parallel.

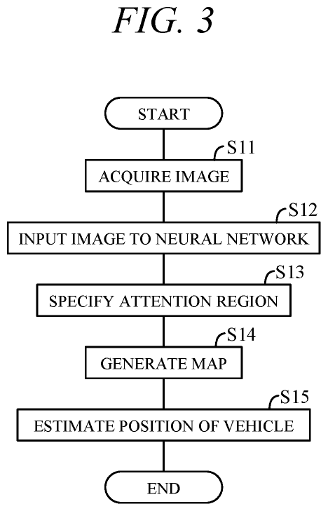

FIG. 3 is a flowchart illustrating one example of processing executed by the controller 10 in FIG. 2 in accordance with a predetermined program. The processing in the flowchart is repeated for each predetermined cycle while the subject vehicle is traveling in the manual drive mode, for example.

As illustrated in FIG. 3, first, when the captured image of the camera 1a is acquired in S11 (S: processing step), the captured image and the captured image of the camera 1a acquired at a time point before a predetermined time from the current point of time are input to the poseCNN in S12. In the poseCNN, the moving amount of the camera 1a (that is, the moving amount of the subject vehicle) is estimated based on the input captured image. In S13, the image feature amount output from the convolutional layer of the poseCNN at the time of estimating the moving amount by the poseCNN is acquired, and the image feature amount is input to the ABN. In the ABN, the attention map indicating the region (attention region) gazed at the time of estimating the poseCNN is generated based on the captured image of the camera 1a acquired in S11 and the input image feature amount. The attention region is specified based on the attention map generated by the ABN. In S14, the feature points are extracted from the captured image acquired by the camera 1a in S11, the feature point corresponding to the attention region specified in S13 among the extracted feature points is plotted on the environmental map stored in the memory unit 12. As a result, the environmental map is sequentially generated. In S15, the position of the subject vehicle is estimated and acquired based on the feature point extracted in S14 and the environmental map stored in the memory unit 12. At this time, the current position of the subject vehicle can be estimated based on the moving amount of the camera 1a as the estimation result of the poseCNN and the previously estimated position of the subject vehicle.

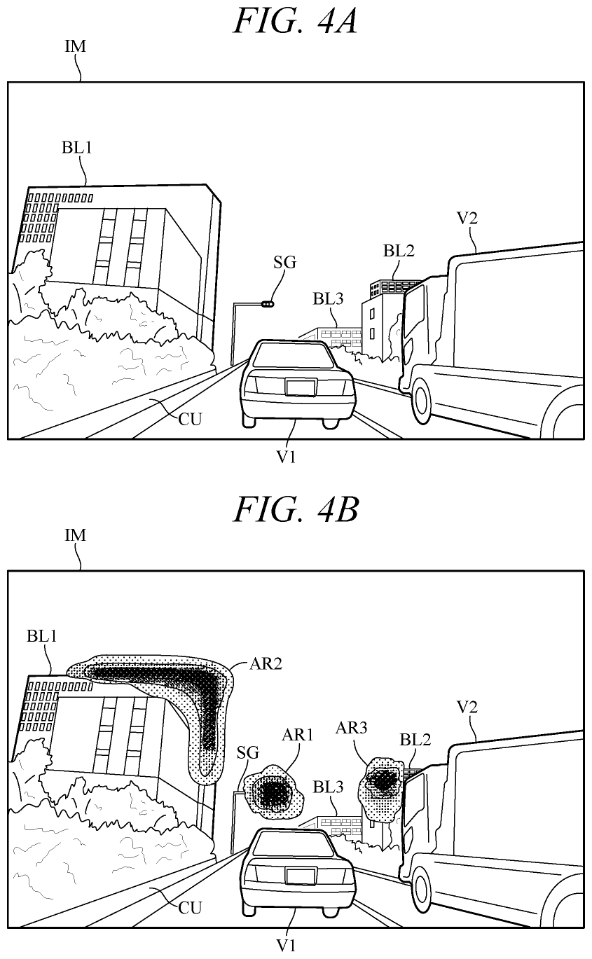

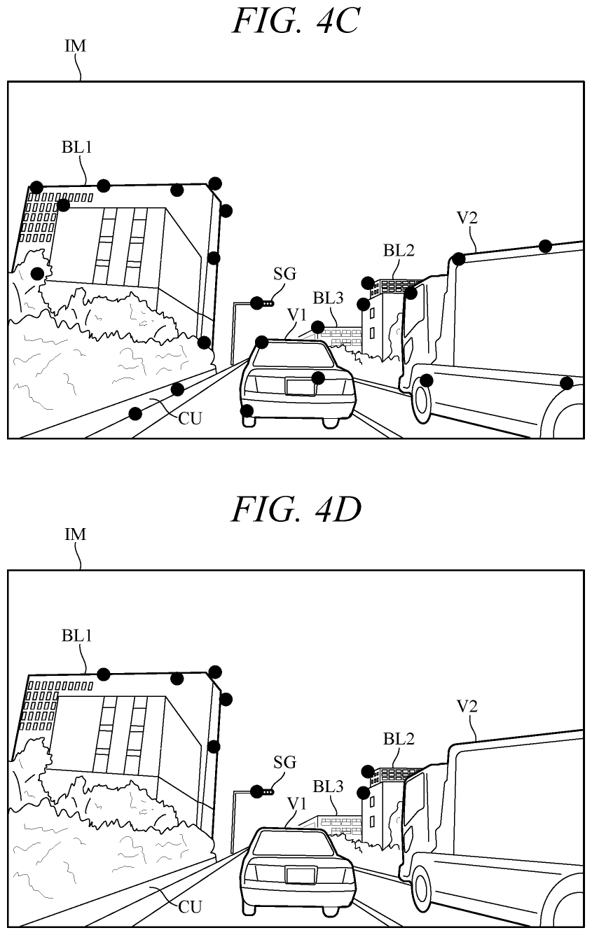

The operation of map generation by the map generation apparatus 50 according to the present embodiment will be described more specifically. FIG. 4A is a diagram illustrating an example of the captured image of the camera 1a. A captured image IM in FIG. 4A includes buildings BL1, BL2, and BL3 around the subject vehicle, a traffic light SG, a curb CU, other vehicles V1 and V2 traveling in front of the subject vehicle, and the like. The captured image IM in FIG. 4A and the captured image of the camera 1a acquired at the time point before a predetermined time from the current point of time are input to the poseCNN, and the moving amount of the subject vehicle is estimated (S12). At this time, the image feature amount output from the convolutional layer of the poseCNN is input to the ABN, and the attention map is generated by the ABN (S13). FIG. 4B is a diagram schematically illustrating the attention map. In the attention map of FIG. 4B, regions including the traffic light SG and portions of the buildings BL1 and BL2 are highlighted as attention regions AR1, AR2, and AR3. In the attention map, a pixel having a higher gaze degree is displayed at a higher density in the attention region. FIG. 4C is a diagram schematically illustrating the feature point extracted from the captured image of FIG. 4A. Among the feature points illustrated in FIG. 4C, the feature point corresponding to the attention region illustrated in FIG. 4B is plotted on the environmental map (S14). FIG. 4D is a diagram schematically illustrating the feature point corresponding to the attention region.

According to the embodiment of the present invention, the following advantageous effects can be obtained:

(1) The map generation apparatus 50 includes the camera 1a that detects an external situation around the subject vehicle, the extraction unit 171 that extracts the feature point from the captured image acquired by the camera 1a, the moving amount estimation unit 172 that estimates the moving amount of the camera 1a accompanying the movement of the subject vehicle based on the captured image, the specifying unit 173 that specifies a region in the captured image used for estimation of the moving amount by the moving amount estimation unit 172, and the generation unit 174 that generates the map information using the feature point corresponding to the region specified by the specifying unit 173 among the feature points extracted by the extraction unit 171. This makes it possible to improve the accuracy of the environmental map while suppressing an increase in the data amount of the environmental map.

(2) The moving amount estimation unit 172 estimates the moving amount of the camera 1a based on the plurality of captured images, acquired by the camera 1a and having different detection time points (image capturing time points), using the pose convolutional neural network, and the specifying unit 173 specifies a region (attention region) in the captured image, which is gazed when the pose convolutional neural network estimates the moving amount of the camera 1a, based on the image feature amount output from the convolutional layer of the pose convolutional neural network. By using the neural network in this manner, it is possible to automatically and accurately specify a region required for estimating the moving amount. Thus, it is possible to suppress that a region unnecessary for estimating the moving amount, for example, a region of a moving body (other vehicles V1, V2 in FIG. 4A) or a region of a distant object (building BL3 in FIG. 4A) is specified as the attention region. In a case of a moving body that is not moving even if recognized as the moving body, the body is automatically specified (calculated) as the attention region necessary for estimating the moving amount, so that for example when the body passes through a side of a vehicle stopped on the road, SLAM (environmental map) generation with higher accuracy can be achieved without human intervention.

(3) The map generation apparatus 50 further includes the memory unit 12 that stores the map information generated by the generation unit 174, and the position estimation unit 131 that estimates and acquires the position of the subject vehicle based on the feature point extracted by the extraction unit 171 and the map information stored in the memory unit 12. The generation of the map information by the generation unit 174 and the estimation of the position of the subject vehicle by the position estimation unit 131 are performed in parallel. This makes it possible to estimate the subject vehicle position with high accuracy based on the environmental map while constructing the environmental map with high accuracy.

The above-described embodiment can be varied into various forms. Hereinafter, some modifications will be described. In the above embodiment, although the situation around the subject vehicle is detected by the camera 1a, an external situation detector may have any configuration as long as the external situation detector detects the situation around the subject vehicle. For example, the external situation detector may be the radar 1b or the LiDAR 1c. In the above embodiment, although the extraction unit 171 extracts the feature point from the image indicated by the captured image data acquired by the camera 1a, the extraction unit may extract the feature point from the image indicated by the detection data of the radar 1b or the LiDAR 1c.

In the above embodiment, the moving amount estimation unit 172 estimates the moving amount of the camera 1a accompanying the movement of the subject vehicle based on the image indicated by the captured image data acquired by the camera 1a; however, the moving amount estimation unit may estimate the moving amount of the radar 1b or the LiDAR 1c accompanying the movement of the subject vehicle based on the image indicated by the detection data of the radar 1b or the LiDAR 1c. In the above embodiment, the generation unit 174 generates the map information using the feature point corresponding to the region specified by the specifying unit 173 among the feature points extracted by the extraction unit 171. However, the generation unit may acquire a gaze degree (a gaze degree by the poseCNN) for each pixel in the gaze region included in the attention map or attached to the attention map, weight each pixel according to the acquired gaze degree for each pixel, and generate the map information using the feature point corresponding to a region whose weight is a predetermined value or more, that is, a region whose gaze degree is a predetermined degree or more, among the feature points in the attention region. For example, in the example illustrated in FIG. 4B, the map information may be generated using the feature point corresponding to the region with the highest density (innermost region) in the attention regions AR1, AR2, and AR3.

In the above embodiment, although the map generation apparatus 50 is applied to the self-driving vehicle, the map generation apparatus 50 is also applicable to vehicles other than the self-driving vehicle. For example, the map generation apparatus 50 can also be applied to a manual driving vehicle including advanced driver-assistance systems (ADAS). In addition, in the above embodiment, although the processing illustrated in FIG. 3 is executed while traveling in the manual drive mode, the processing illustrated in FIG. 3 may be executed while traveling in the self-drive mode.

The present invention also can be configured as a map generation method including: extracting one or more feature points from an image indicated by a detection data acquired by an external situation detector configured to detect an external situation around a subject vehicle; estimating a moving amount of the external situation detector accompanying the movement of the subject vehicle based on the image indicated by the detection data; specifying a region in the image used for estimation of the moving amount in the estimating; and generating a map information using one or more feature points corresponding to the region specified in the specifying among the feature points extracted in the extracting.

The above embodiment can be combined as desired with one or more of the above modifications. The modifications can also be combined with one another.

According to the present invention, it is possible to improve the accuracy of the environmental map while suppressing an increase in the data amount of the environmental map.

Above, while the present invention has been described with reference to the preferred embodiments thereof, it will be understood, by those skilled in the art, that various changes and modifications may be made thereto without departing from the scope of the appended claims.

What is claimed is:

1. A map generation apparatus comprising:
an external situation detector configured to detect an external situation around a subject vehicle; and
a microprocessor and a memory connected to the microprocessor, wherein the microprocessor is configured to perform:
extracting one or more feature points from an image indicated by a detection data acquired by the external situation detector;
estimating a moving amount of the external situation detector accompanying the movement of the subject vehicle based on the image indicated by the detection data;
specifying a region in the image used for estimation of the moving amount in the estimating; and
generating a map information using one or more feature points corresponding to the region specified in the specifying among the feature points extracted in the extracting.

2. The map generation apparatus according to claim 1, wherein
the microprocessor is configured to perform
the estimating including estimating the moving amount of the external situation detector based on a plurality of the images indicated by a plurality of the detection data having different detection time points, using a neural network; and
the specifying including specifying a region in an image, which is gazed when the neural network estimates the moving amount of the external situation detector.

3. The map generation apparatus according to claim 2, wherein
the neural network is a pose convolutional neural network, and
the microprocessor is configured to perform
the specifying including specifying a region in the image, which is gazed when the neural network estimates the moving amount of the external situation detector, based on the image feature amount output from a convolutional layer of the neural network.

4. The map generation apparatus according to claim 3, wherein
the microprocessor is configured to perform
the generating including acquiring a gaze degree of the neural network for each pixel of the region specified in the specifying and generating the map information using one or more feature points whose gaze degree are a predetermined degree or more among feature points in the region specified in the specifying.

5. The map generation apparatus according to claim 1, wherein
the memory stores the map information generated by the generation unit, and
the microprocessor is configured to further perform
estimating and acquiring a position of the subject vehicle based on the feature points extracted in the extracting and the map information stored in the memory, and wherein
the microprocessor is configured to perform the generation of the map information in the generating and the estimation of the position of the subject vehicle in the estimating in parallel.

6. A map generation apparatus comprising:
an external situation detector configured to detect an external situation around a subject vehicle; and
a microprocessor and a memory connected to the microprocessor, wherein
the microprocessor is configured to perform as:
an extraction unit configured to extract one or more feature points from an image indicated by a detection data acquired by the external situation detector;
a moving amount estimation unit configured to estimate a moving amount of the external situation detector accompanying the movement of the subject vehicle based on the image indicated by the detection data;
a specifying unit configured to specify a region in the image used for estimation of the moving amount by the moving amount estimation unit; and
a generation unit configured to generate a map information using one or more feature points corresponding to the region specified by the specifying unit among the feature points extracted by the extraction unit.

7. The map generation apparatus according to claim 6, wherein
the moving amount estimation unit estimates the moving amount of the external situation detector based on a plurality of the images indicated by a plurality of the detection data having different detection time points, using a neural network; and
the specifying unit specifies a region in an image, which is gazed when the neural network estimates the moving amount of the external situation detector.

8. The map generation apparatus according to claim 7, wherein
the neural network is a pose convolutional neural network, and
the specifying unit specifies a region in the image, which is gazed when the neural network estimates the moving amount of the external situation detector, based on the image feature amount output from a convolutional layer of the neural network.

9. The map generation apparatus according to claim 8, wherein
the generation unit acquires a gaze degree of the neural network for each pixel of the region specified by the specifying unit and generates the map information using one or more feature points whose gaze degree are a predetermined degree or more among feature points in the region specified by the specifying unit.

10. The map generation apparatus according to claim 6, wherein
the memory stores the map information generated by the generation unit, and
the microprocessor is configured to further perform as
a position estimation unit configured to estimate and acquire a position of the subject vehicle based on the feature points extracted by the extraction unit and the map information stored in the memory, and wherein
the generation of the map information by the generation unit and the estimation of the position of the subject vehicle by the position estimation unit are performed in parallel.

11. A map generation method comprising:
extracting one or more feature points from an image indicated by a detection data acquired by an external situation detector configured to detect an external situation around a subject vehicle;
estimating a moving amount of the external situation detector accompanying the movement of the subject vehicle based on the image indicated by the detection data;
specifying a region in the image used for estimation of the moving amount in the estimating; and
generating a map information using one or more feature points corresponding to the region specified in the specifying among the feature points extracted in the extracting.
